(19) United States
(12) Patent Application Publication
(10) Pub. No.: US 2009/0318288 A1
(43) Pub. Date: Dec. 24, 2009

(54) CARBON-ENRICHED MATERIAL

(76) Inventors: Andreas Enderich, Essllingen (DE); Birgit Renz, Marbach (DE); Jorg Von Seggern, Essllingen (DE); Hartmut Sauter, Renningen (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/487,060

(22) Filed: Jun. 18, 2009

(30) Foreign Application Priority Data
Jun. 19, 2008 (DE) 102008029079.3

(51) Int. Cl. C01B 31/08

(52) U.S. Cl. 502/417

(57) ABSTRACT

The present invention relates to a carbon-enriched material for hydrocarbon adsorption, which exhibits at least one base material and carbon as the integrated filler. It is here essential to the invention for the product to exhibit a base material consisting of plastic and carbon as the filler. The invention also relates to the use of a carbon-enriched paper (2) in an intake tract of a motor vehicle.

The present invention relates to a carbon-enriched material that exhibits at least one base material and carbon as the integrated filler according to the preamble to claim 1. The invention also relates to the use of such a carbon-enriched material with paper or plastic as the base material. In addition, the invention relates to an intake tract of a combustion engine according to the preamble to claim 4, as well as a motor vehicle equipped with such an intake tract.

Increasingly stringent environmental regulations are making it more and more necessary to evaluate and consider the overall balance of emitted hydrocarbons in a motor vehicle. Hydrocarbons are usually constituents in diesel and regular gasoline, and remain in the exhaust gas of a combustion engine even after burned. In conjunction with nitrogen oxide and sun exposure, these substances can change into organic compounds that irritate the mucous membranes, thereby contributing significantly to the formation of so-called summer smog. For these reasons, many parts of the world already have upper limits that curtail the emission of volatile hydrocarbons. In particular the state of California in the U.S. is a leader in this regard. In general, a distinction is here made between so-called “fuel emission” and “non-fuel emission” for motor vehicles, wherein the former derives its origin from the fuel or fuel system, while the latter do not stem from the fuel or a fuel system. In order to achieve a lasting reduction in overall levels of hydrocarbon emissions, attention must hence be focused on both the hydrocarbon emissions arising from the fuel or fuel system, and the hydrocarbon emissions from other parts of the motor vehicle.

Known from EP 1 840 264 A1 is a paper enriched with carbon or a cardboard, wherein the paper exhibits at least one fibrous material and carbon as the filler. The content of carbon here measures at least 15% v/v relative to the solid volume of the paper, while the overall filler content including all present fillers measures approx. 30 to 60% w/w relative to the dry total weight of the paper. This paper can be used in a pyrolysis procedure followed by infiltration with silicon to manufacture ceramic items, which can exhibit extremely thin walls, thereby enabling a structural ceramic with an exceedingly complex design not possible with other molding processes, for example extrusion or injection molding.

Known from JP 58072669A is an air filter that exhibits an annular filter element inserted in a filter casing. The filter element here carries a flow from radially outside to radially inside, and consists predominantly of activated carbon to absorb hydrocarbon.

The object of the present invention is to reduce the total emission of discharged hydrocarbons in motor vehicles.

This object is achieved according to the invention by the subject matter of the independent claims. Advantageous embodiments are the subject matter of the dependent claims.

The invention is based on the general idea of designing areas of a motor vehicle previously not taken into account in terms of hydrocarbon emission out of a hydrocarbon-absorbing material, or coating it with such a hydrocarbon-absorbing material. Such a hydrocarbon-absorbing material can consist of paper, for example, with a fibrous material-exhibiting material and carbon as the filler. For example, this paper can be arranged separately from an air filter in an intake tract of a combustion engine, and there at least reduce an outward creep of hydrocarbons from the combustion engine with the motor vehicle engine turned off. Of course, the total emission content of hydrocarbons that still escapes to the outside from the intake tract of a combustion engine that has been turned off is exceedingly slight, but hardly negligibly small. Paper arranged in this area and enriched with carbon here reliably minimizes the outward creep of hydrocarbons, thereby improving the overall balance of the motor vehicle. Of course, it is here also conceivable that such a carbon-enriched material be used for hydrocarbon adsorption in the ducts of a ventilation or air conditioning system.

In another generally idea of the invention, the carbon-enriched material can exhibit a plastic as the base material and carbon as the filler, and this composition can be used, for example, for interior finishing components, such as an inner cladding, a roof liner or a dashboard. A considerable amount of hydrogen is usually bound in these interior finishing components as well as in the dashboard, but exits the material and into the environment over the course of time. This exiting of hydrocarbon is perceived as a distinct smell, in particular in brand new cars. This characteristic smell tapers off over time, which reflects emissions that continuously diminish. In spite of everything, the hydrocarbons contained in the mentioned and other components of the motor vehicle, which can diffuse into the environment with the passage of time, also have to be included in the overall balance, and can in no way be disregarded. Therefore, if the plastic of the respective interior finishing components is enriched with carbon as proposed by the invention, wherein the carbon of course forms an integral constituent of the material and usually cannot be removed from the latter, a high adsorption rate for hydrocarbons can be achieved, thereby tangibly reducing the emission behavior of the respective components. Therefore, enriching several or preferably the overwhelming majority of interior finishing components with such a carbon makes it possible to exert an extremely positive influence on the overall balance of hydrocarbons in a respective motor vehicle.

The carbon-enriched paper is in an intake tract of a combustion engine is preferably dimensioned in such a way that it can absorb at least 0.1 g of hydrocarbon/g of carbon. Dimensioning during the adaptation process must be performed in such a way as to minimize the mass of hydrocarbon exiting the intake branch. During operation of the combustion engine, the carbon-enriched paper is here backwashed, and thereby cleaned.

In another advantageous embodiment of the solution according to the invention, the carbon-enriched paper is arranged in a sink of an air intake channel of the intake tract. Since hydrocarbons are heavier than air, this type of arrangement offers a reliable way to absorb the hydrocarbons diffusing outwardly through the intake tract, which usually diffuse through the sink.

Additional important features and advantages of the invention may be gleaned from the subclaims, drawings and accompanying figure description based on the drawings.

Let it be understood that the features mentioned above and yet to be described can be used not just in the respectively indicated combination, but also in other combinations or alone, without departing from the framework of the present invention.

Preferred exemplary embodiments of the invention are shown on the drawings, and will be explained in greater detail in the following description, wherein the same reference numbers relate to the same or similar or functionally identical components.

Shown diagrammatically on:

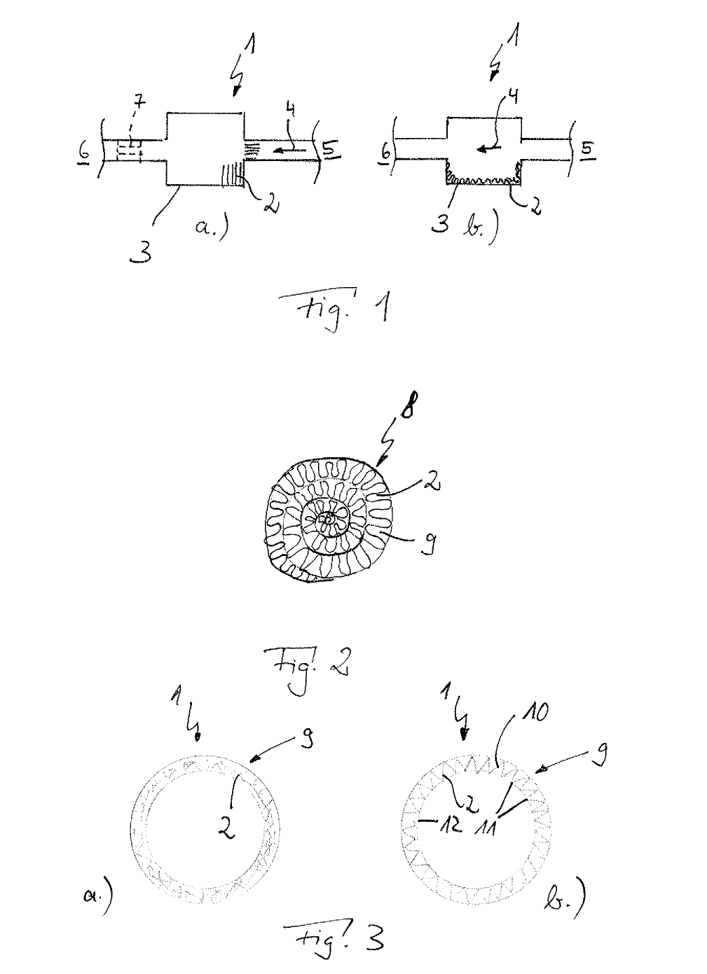

FIG. 1a is carbon-enriched paper according to the invention in the area of an air intake channel of an intake tract, or in a duct of a ventilation/air conditioning system of a motor vehicle;

FIG. 1b is a representation as in FIG. 1a, but for another embodiment;

FIG. 2 is a winding filter made out of the carbon-enriched paper according to the invention;

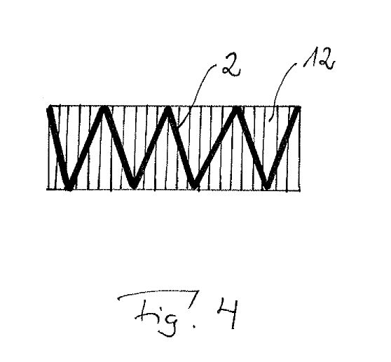

FIG. 3 are possible claddings for air-carrying channels;

FIG. 4 is a combination of a filter element with the carbon-enriched paper according to the invention.

As depicted on FIG. 1a, an air intake channel 1 exhibits an intake tract of a combustion engine (not shown in any greater detail), for example in a motor vehicle, a carbon-enriched paper 2 with a fibrous material-exhibiting base material and carbon as the filler for hydrocarbon adsorption. The carbon-enriched paper 2 is here preferably arranged in a sink 3 of the air intake channel 1, and in this area absorbs hydrocarbons that diffuse into the open through the air intake channel 1 from a combustion engine that that has been turned off. The diffusion direction is here denoted with the arrow 4, which usually leads from a combustion engine side 5 to the outside 6.

With the combustion engine running, air is aspirated through the air intake channel 1 opposite the direction of arrow 4, meaning from the outside 6 toward the side 5 of the combustion engine, and into the latter. Of course, another air filter 7 is preferably arranged in front of the outside 6, as represented on FIG. 1a by a dashed line. Hence, this air filter 7 is arranged separately from the carbon-containing paper, wherein the latter can be backwashed with fresh air aspirated from the outside 6 with the combustion engine running.

As evident from FIG. 1b, the carbon-enriched paper 2 according to the invention lines the entire area of the sink 3, and therefore can absorb a sufficient quantity of hydrocarbons. In general, the reference number 1 is here intended to stand not just for an air intake channel, but can also denote a duct of a ventilation/air conditioning system of a motor vehicle, for example.

The carbon-enriched paper 2 according to the invention, which exhibits a fibrous material-containing base material and carbon as the filler for hydrocarbon adsorption, can of course also be used in a filter 8, as shown by example on FIG. 2, in particular in a winding filter. As opposed to pure air filters, the individual channels 9 of the filter 8 can here be open at both ends, since the filter 8 generally serves to adsorb hydrocarbon with the combustion engine turned off, and otherwise is intended to generate as little flow resistance ad possible, i.e., in particular with the combustion engine running. It is also conceivable to use the paper 2 according to the invention in a fuel filter (not shown) for cleaning the water it separated out.

In another embodiment of the material according to the invention, said material exhibits a base material made of plastic and carbon as the filler. Such a material has an adsorptive capacity for the adsorption of hydrocarbons that should not be underestimated and depends on the percentage of carbon, and can therefore be used for a dashboard of a motor vehicle and/or interior finishing component of a motor vehicle, in particular in a roof lining, for example. Brand new motor vehicles typically exhibit a characteristic smell that the customer, meaning the buyer of the motor vehicle, usually associates with the newness of the motor vehicle. This characteristic smell stems predominantly from hydrocarbons being given off from the interior finishing components, for example the roof lining or dashboard, and only abates over time. However, since not just the hydrocarbons generated and then discharged by the combustion engine of the motor vehicle are to be included on the balance sheet, but rather the total level of hydrocarbon emissions, it is necessary to stop hydrocarbons from diffusing out of the interior finishing components of the motor vehicle to the greatest extent possible. For example, this can be accomplished by the material according to the invention, which when combined with carbon as the integral constituent offers an adsorptive capacity for hydrocarbons that cannot be underestimated, so that the latter do not get into the environment in the first place.

In general, it is also conceivable for the base material to be carbon adsorption-filled plastic, for example processed into air-carrying components via spraying or blowing.

This overall balance of hydrocarbons also encompasses hydrocarbons that creep out of the intake tract of the combustion engine of the motor vehicle when not turned on, which can also be greatly reduced by a carbon-enriched paper arranged in the air intake channel 1 of the combustion engine.

In general, the carbon-enriched material according to the invention, which exhibits paper or plastic as the base material and carbon as the filler, for example, makes it possible to tangibly improve the overall balance of hydrocarbon emission for a motor vehicle when used on the locations in the motor vehicle mentioned in the preceding paragraphs. The carbon is here bound with the base material of the product in such a way as to prevent the latter from detaching.

FIG. 3 shows additional areas of application for the carbon-enriched paper 2 according to the invention, wherein the latter is designed as a pleated star 10 according to FIG. 3b. In this case, the inner longitudinal edges 11 of the pleated star 10 can be embedded in a notch 12, thereby providing a support and assembly aid for the pleated star 10. The notch 12 is designed as a lattice structure, for example, thereby enabling the free supply of air to the pleated star 10. When providing the carbon-enriched paper 2, orienting the pleated star 10 in the air intake channel/ventilating channel produces virtually no additional flow resistance.

By contrast, the filter material as shown on FIG. 3a is not designed as a pleated star 10.

It is also conceivable to use the carbon-enriched paper 2 in combination with another filter, for example a paper filter 12, as depicted on FIG. 4. It must here also be remembered that the carbon-enriched paper 2 is arranged in such a way that the paper filter 12 preferably generates no additional flow resistance as a result of the prescribed flow direction.

1. A carbon-enriched material for hydrocarbon adsorption, which exhibits at least one base material and carbon as the integrated filler,
characterized in that
the product exhibits a base material made of plastic and carbon as the filler.

2. A use of a carbon-enriched paper (2) with a fibrous material-exhibiting base material and carbon as the filler for hydrocarbon adsorption in the following locations, specifically
in an intake tract of a combustion engine, separately from an air filter (7), and/or
in a duct (1) of a ventilation/air conditioning system of a motor vehicle, and/or
in a filter (8), in particular a winding filter, and/or
in a fuel filter for cleaning the water separated out there.

3. The use of a carbon-enriched plastic according to claim 1 as a hydrocarbon absorber in at least the following components, specifically
a dashboard of a motor vehicle, and/or
an interior finishing component of a motor vehicle, in particular a roof lining.

4. An intake tract of a combustion engine,
characterized in that
a carbon-enriched paper (2) is provided as the hydrocarbon absorber in the intake tract separately from an air filter (7), wherein the paper (2) exhibits at least one fiber as the bas material and carbon as the filler.

5. The intake tract according to claim 4,
characterized in that
the paper (2) is arranged on a clean side of the air filter (7), i.e., between the latter and a combustion chamber of the combustion engine.

6. The intake tract according to claim 4 or 5,
characterized in that
the paper (2) is arranged in a sink (3) of an air intake channel (1) of the intake tract.

7. The intake tract according to one of claims 4 to 6,
characterized in that
the carbon-enriched paper (1) is dimensioned in such a way that it can absorb at least 0.5 g of hydrocarbon.

8. A motor vehicle with an intake tract according to one of claims 4 to 7.
